(19) United States
(12) Patent Application Publication
(10) Pub. No.: US 2005/0112435 A1
(43) Pub. Date: May 26, 2005

(54) Polymer electrolyte membrane and polymer electrolyte fuel cell

(75) Inventors: Motokazu Kobayashi, Kanagawa (JP); Masayuki Yamada, Tokyo (JP); Zuyi Zhang, Kanagawa (JP); Shinji Eritate, Kanagawa (JP); Teigo Sakakibara, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/980,299

(22) Filed: Nov. 4, 2004

(30) Foreign Application Priority Data
Nov. 12, 2003 (JP) 2003-382582

(51) Int. Cl. H01M 8/10; H01M 8/04; H01M 8/12; C25B 13/00; C25C 7/04

(52) U.S. Cl. 429/30; 204/296; 429/33

(57) ABSTRACT

There are provided a polymer electrolyte membrane having at least one surface with an average surface roughness Ra′ of from 30 nm to 500 nm and a surface area ratio Sr of 1.2 or more in which Sr is defined as S/S₀ with S₀ representing a surface area when the at least one surface is ideally flat and S representing an actual surface area of the at least one surface, and a polymer electrolyte fuel cell comprising the polymer electrolyte membrane. Thereby, a polymer electrolyte fuel cell is provided that improves the efficiency of contact between the polymer electrolyte membrane and the catalyst, efficiently separates hydrogen ions and electrons produced on the catalyst, and provides high output characteristics.

### BACKGROUND OF THE INVENTION

1. Field of the Invention

The present invention relates to a solid polymer electrolyte membrane (hereinafter, simply referred to as “polymer electrolyte membrane”) and a polymer electrolyte fuel cell (PEFC) (referred to also as “proton exchange membrane fuel cell (PEM-FC)”) using the same. More particularly, the present invention relates to a polymer electrolyte fuel cell that uses hydrogen, reformed hydrogen, methanol, dimethyl ether or the like, as a fuel, and air or oxygen, as an oxidizer.

2. Related Background Art

As shown in FIG. 5, a polymer electrolyte fuel cell has a layer structure in which a polymer electrolyte membrane 13 is held between a fuel electrode (anode) 11 and an air electrode (cathode) 12. The fuel electrode and the air electrode each comprise a mixture of a catalyst having a noble metal such as platinum or an organometallic complex carried by conductive carbon, an electrolyte and a binder. Fuel supplied to the fuel electrode passes through fine pores of the electrode, reaches the catalyst, and releases electrons by the action of the catalyst to become hydrogen ions. The hydrogen ions pass through the electrolyte membrane provided between the both electrodes, reach the air electrode, and react with oxygen supplied to the air electrode and electrons flowing from an external circuit into the air electrode to produce water. The electrons released from the fuel pass through the catalyst and the conductive carbon carrying the catalyst in the electrode, are guided to the external circuit, and flow into the air electrode from the external circuit. As a result, in the external circuit, electrons flow from the fuel electrode to the air electrode so that an electric power is taken out.

In other words, when hydrogen is used as a fuel, for example, a reaction of the following reaction formula (1) occurs in the fuel electrode. Also, a reaction of the following reaction formula (2) occurs in the air electrode.
Fuel electrode H₂→2H⁺+2e⁻ (1)
Air electrode ½O₂+2H⁺+2e⁻→H₂O (2)

The conductive carbon, which is a carrier for the catalyst, is a conductor of the electrons of the above reaction, and the polymer electrolyte is a conductor of the hydrogen ions. Therefore, at the interface between the electrode and the polymer electrolyte, the conductive carbon and the polymer electrolyte each need to be formed in a network structure so that the conduction of electrons and hydrogen ions smoothly takes place, respectively.

A typical electrolyte membrane is generally a perfluorosulfonic acid membrane known under the trade name of Nafion (Registered Trademark, manufactured by DuPont).

The perfluorosulfonic acid membrane is a copolymer of perfluorovinyl ether having sulfonic acid group as electrolyte group and tetrafluoroethylene and is widely used as an electrolyte membrane for a polymer electrolyte fuel cell.

The electrode is generally obtained by coating one surface of carbon paper or carbon cloth with a mixture of carbon particles carrying a catalyst such as platinum and a perfluorosulfonic acid polymer solution and pressure-bonding the coated surface to an electrolyte membrane.

Conventionally, in order to improve the characteristics of the fuel cell, various improvements have been done to methods of defining fine pores of carbon particles and carrying platinum or the like thereon.

For example, a method is disclosed in which in order to carry noble metal particles as a catalyst on a fine carbon powder in a highly dispersed state, a three-dimensional structure of the fine carbon powder, which is a carrier, is destroyed to increase the adsorption sites of the noble metal particles (see Japanese Patent Application Laid-Open No. S63-319050).

Also, the use of a fine carbon powder is disclosed in which the volume occupied by fine pores having a diameter of 8 nm or less is 500 cm³/g or less (see Japanese Patent Application Laid-Open No. H9-167622).

Since the polymer electrolyte is a conductor of hydrogen ions, it conducts hydrogen ions produced according to the above reaction formula (1) from the fuel electrode to the air electrode. Further, electrons produced at the same time pass along the catalyst or through a stack of conductive carbon carrying the catalyst, are collected in a current collector, and flow to the external circuit. In other words, the catalyst needs to be in contact with both the polymer electrolyte and the conductive carbon, and a catalyst that is in contact with only one of them do not contribute to the reaction.

In the conventional methods disclosed in Japanese Patent Application Laid-Open Nos. S63-319050 and H9-167622 as described above, the contact rate between noble metal particles as a catalyst and conductive carbon improves, however, many catalyst particles cannot be brought into contact with the electrolyte, so that an expensive noble metal catalyst cannot be used effectively. In other words, some catalyst particles do not contribute to reaction.

The present invention has been accomplished to solve the conventional problems as described above and provides a polymer electrolyte fuel cell that improves the efficiency of contact between the polymer electrolyte membrane and the catalyst, efficiently separates hydrogen ions and electrons produced on the catalyst, and shows high output characteristics.

In addition, the present invention provides a polymer-electrolyte membrane for use in the above polymer electrolyte fuel cell that shows the high output characteristics.

### SUMMARY OF THE INVENTION

According to a first aspect of the present invention, there is provided a polymer electrolyte membrane having at least one surface with an average surface roughness Ra′ of from 30 nm to 500 nm and a surface area ratio Sr of 1.2 or more in-which Sr is defined as S/S₀ with S₀ representing a surface area when the at least one surface is ideally flat and S representing an actual surface area of the at least one surface.

According to a second aspect of the present invention, there is provided a polymer electrolyte fuel cell comprising the above polymer electrolyte membrane.

With the present invention, by specifically defining the average surface roughness Ra′ and surface area ratio Sr of the polymer electrolyte membrane, a polymer electrolyte fuel cell can be provided that improves the efficiency of contact between the polymer electrolyte membrane and the catalyst, efficiently separates hydrogen ions and electrons produced on the catalyst, and provides high output characteristics.

Further, with the present invention, a polymer electrolyte membrane can be provided for use in the above polymer electrolyte fuel cell that provides high output characteristics.

Other features and advantages of the present invention will be apparent from the following description taken in conjunction with the accompanying drawings.

### BRIEF DESCRIPTION OF THE DRAWINGS

FIG. 1 is a partial schematic view showing a polymer electrolyte fuel cell of the present invention;

FIG. 2 is an electron microphotograph of a thin film of the polymer electrolyte membrane in Example 4;

FIG. 3 is an electron microphotograph of a thin film of the polymer electrolyte membrane in Comparative Example 1;

FIG. 4 is a graphical representation showing the relationship between current and voltage in the fuel cells in Examples 1 to 4 of the present invention and Comparative Example 1; and

FIG. 5 is a partial schematic view showing a conventional polymer electrolyte fuel cell.

### DESCRIPTION OF THE PREFERRED EMBODIMENTS

The present invention is described in detail below with reference to the drawings.

The polymer electrolyte membrane of the present invention is characterized in that at least one surface of the polymer electrolyte membrane has an average surface roughness Ra′ of from 30 nm to 500 nm and a surface area ratio Sr of 1.2 or more.

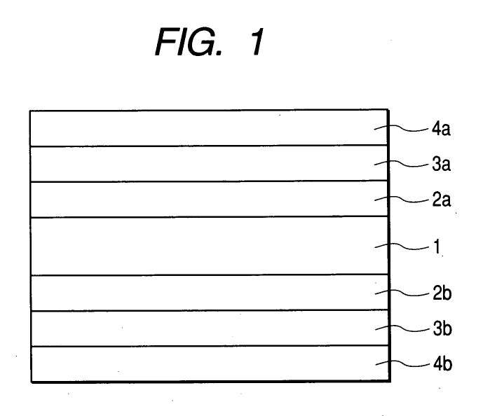

FIG. 1 is a partial schematic view showing a polymer electrolyte fuel cell of the present invention.

In FIG. 1, in the polymer electrolyte fuel cell of the present invention, on both sides of a polymer electrolyte membrane 1, electrode catalyst layers 2a and 2b are respectively provided, on outside of which, diffusion layers 3a and 3b are respectively provided, on outside of which, an electrode (fuel electrode) 4a and an electrode (air electrode) 4b that also serve as current collectors are respectively provided.

As polymer electrolyte membrane 1, perfluorosulfonic acid polymer membranes represented by Nafion membranes manufactured by DuPont, hydrocarbon membranes manufactured by Hoechst, and the like are preferably used. However, polymer electrolyte membrane 1 is not limited to these, and polymer membranes having functional groups with hydrogen ion conductivity, for example, sulfonic acid groups, sulfinic acid groups, carboxylic acid groups and phosphonic acid groups, can be widely used.

Further, hybrid electrolyte membranes of an inorganic electrolyte and a polymer membrane made by sol-gel processes, and the like can also be used.

The polymer electrolyte membrane of the present invention is characterized by having at least one surface with such an unevenness that the average surface roughness Ra′ is from 30 nm to 500 nm, and the surface area ratio Sr is 1.2 or more.

By putting an electrode catalyst as described below in this unevenness and effecting bonding, the amount of the catalyst that contributes to the reaction increases remarkably, thereby improving the reaction efficiency.

There are several methods for providing a surface of an electrolyte membrane with an average surface roughness Ra′ of from 30 nm to 500 nm and a surface area ratio Sr of 1.2 or more, including, for example, a method of mechanically abrading the surface of the electrolyte membrane by sandblasting or the like, a method of roughening the surface of the electrolyte membrane by plasma irradiation or the like, a method of previously making a metal surface uneven by anodization or the like to provide a mold, coating the uneven surface of the mold with a raw material liquid capable of forming an electrolyte membrane, and hardening the liquid by drying or polymerization to transfer the unevenness, a method of pressing an electrolyte membrane to a mold with an unevenness under heating to transfer the uneven shape of the mold, and the like. These methods are not specifically limited and may also be combined.

The term “average surface roughness Ra′” of the thus made electrolyte membrane as herein employed refers to a concept obtained by applying central line average roughness Ra defined by JIS B 0601 to a measured surface and effecting three-dimensional extension, which is expressed as “a value obtained by averaging the absolute values of deviations from a reference plane to a designated plane” and given by the following expression (1).

$${Ra}^{′} = \frac{1}{{S}_{0}} {\int }_{{Y}_{B}}^{{Y}_{T}} {\int }_{{X}_{L}}^{{X}_{R}} \vert F ( X , Y - {Z}_{0} ) \vert {ⅆ}_{X} {ⅆ}_{Y} \qquad ( 1 )$$

wherein
Ra′ is an average surface roughness value (nm);
S₀ is an area (nm²) of a measured surface when the measured surface is ideally flat and is given by |X_{R}−X_{L}|×|Y_{T}−Y_{B}|;
F(X, Y) is a height (nm) at a measured point (X, Y) in which X is an X-coordinate and Y is a Y-coordinate;
X_{L} to X_{R}: the range of the X coordinate of the measured surface;
Y_{B} to Y_{T}: the range of the Y coordinate of the measured surface; and
Z₀: an average height (nm) in the measured surface.

The average surface roughness Ra′ is measured using a scanning probe microscope (SPM).

It is desired that the average surface roughness Ra′ of the polymer electrolyte membrane of the present invention is not less than 30 nm but no more than 500 nm, preferably not less than 40 nm but no more than 450 nm. If Ra′ is less than 30 nm, the recesses of the surface are too small so that some electrode catalyst particles cannot be contained therein, which is not preferable. If Ra′ is more than 500 nm, contribution to the improvement of the contact area between the electrode catalyst and the electrolyte membrane is small, which is not preferable.

The surface area ratio Sr of the polymer electrolyte membrane of the present invention is obtained by Sr=S/S₀ wherein S₀ is a surface area of a measured surface when the measured surface is ideally flat and S is a surface area of an actual measured surface.

The surface area is measured using a scanning probe microscope (SPM).

A surface profile image observed by the SPM expresses height data on an xy-plane. In the surface profile image, with respect to a height data (z-coordinate) point on the xy-plane, a surface is approximated by a triangle determined by three adjacent points, and the sum of the approximations is defined as the surface area S by the image observation.

The larger the surface area ratio Sr (Sr=S/S₀) value, the larger the surface unevenness. When the surface is completely smooth, Sr is 1.

It is desired that the surface area ratio Sr of the polymer electrolyte membrane of the present invention is 1.2 or more, preferably 1.3 or more. If. the surface area ratio Sr is less than 1.2, contribution to the improvement of the contact area between the electrode catalyst and the electrolyte membrane is small, which is not preferable.

The electrode catalyst layer 2a on the fuel electrode side comprises an electrode catalyst having at least a platinum catalyst carried by conductive carbon and having an organic group that is capable of hydrogen ion dissociation.

It is preferred that a platinum catalyst used in the electrode catalyst layers of the present invention is carried on a surface of conductive carbon. It is preferred that the average particle diameter of the carried catalyst is small, specifically within the range of 0.5 nm to 20 nm, more preferably from 1 nm to 10 nm. If the average particle diameter is less than 0.5 nm, the activity of the catalyst particles themselves is too high, so that handling will be difficult. If the average particle diameter is more than 20 nm, the surface area of the catalyst decreases and thus the reaction sites decrease, so that the activity may decrease.

Instead of the platinum catalyst, platinum group metals such as rhodium, ruthenium, iridium, palladium and osmium may be used, or an alloy of platinum and these metals may be used. Especially when methanol is used as a fuel, it is preferred to use an alloy of platinum and ruthenium.

The conductive carbon that can be used in the present invention can be selected from carbon black, carbon fiber, graphite, carbon nanotube and the like.

Also, the average particle diameter of the conductive carbon is preferably within the range of 5 nm to 1,000 nm, more preferably within the range of 10 nm to 100 nm. In actual use, however, since aggregation occurs to some degree, the particle diameter distribution will be from 20 nm to 1,000 nm or more. Further, in order to carry the above catalyst, it is preferred that the specific surface area is large to some degree, specifically 50 m²/g to 3,000 m²/g, more preferably 100 m²/g to 2,000 m²/g.

As the method of carrying a catalyst on the surface of conductive carbon, known methods can widely be used. For example, a method is known which comprises impregnating conductive carbon with a solution of platinum and other noble metals and then reducing the noble metal ions to be carried on the surface of the conductive carbon, as disclosed in Japanese Patent Application Laid-Open No. H2-111440, Japanese Patent Application Laid-Open No. 2000-003712 and the like. Also, a noble metal to be carried may be used as a target and carried on conductive carbon by a vacuum film-forming method such as sputtering.

The thus made electrode catalyst is bonded to the polymer electrolyte membrane and a diffusion layer as described below, alone or in combination with a binder, a polymer electrolyte, a water repellant, conductive carbon, a solvent and the like.

The diffusion layers 3a and 3b can efficiently and uniformly introduce hydrogen, reformed hydrogen, methanol, or dimethyl ether, which is a fuel, and air or oxygen, which is an oxidizer, into the electrode catalyst layers and can also be in contact with the electrodes to transfer electrons. Generally, conductive porous films are preferred, and carbon paper, carbon cloth, a composite sheet of carbon and polytetrafluoroethylene, and the like are used.

The surface and inside of the diffusion layer may be coated with a fluoro paint to effect a water repellent treatment.

As the electrodes 4a and, 4b, any conventional electrode can be used without particular limitation as long as it can efficiently supply a fuel or oxidizer to each diffusion layer and transfer electrons to or from the diffusion layer.

While the fuel cell in accordance with the present invention is made by stacking the polymer electrolyte membrane, the electrode catalyst layers, the diffusion layers and the electrodes as shown in FIG. 1, it can be of any shape, and its production method is not specifically limited and any conventional method can be used.

### EXAMPLES

The present invention is illustrated in more detail below with reference to examples thereof. The present invention is not limited to the following examples.

Examples of production of the polymer electrolyte membrane are illustrated below.

### Example 1

A sheet of Nafion 112 (perfluorosulfonic acid polymer film manufactured by DuPont) was used to prepare an electrolyte membrane. Specifically, the both surfaces of this polymer film were subjected to a plasma treatment in a vacuum vessel at an oxygen partial pressure of 10 Pa at a power density of 0.3 W/cm² for 8 minutes to obtain a polymer electrolyte membrane.

### Example 2

An aluminum plate was subjected to an anodization treatment in a 10% aqueous sulfuric acid solution at 20° C. at a current density of 1 A/dm² for one hour. Then, the aluminum plate was immersed in a 5% aqueous phosphoric acid solution at 50° C. and dissolved for 12 minutes. A surface layer having a number of fine needle-like protrusions was formed for use as a mold.

Further, a sheet of Nafion 112 (perfluorosulfonic acid polymer film manufactured by DuPont) was sandwiched by two of the molds obtained above and pressure-bonded at 100° C. at 5 MPa for 10 minutes to obtain a polymer electrolyte membrane having fine unevenness provided on both surfaces of the Nafion film.

### Example 3

Two of the molds used in Example 2 were prepared, and a surface of each mold was coated with a 5% Nafion 117 solution (manufactured by Wako Pure Chemical Industries, Ltd.) in a dry film thickness of 60 μm and dried in a dryer at 80° C. for 30 minutes. The surfaces of the dry Nafion films were attached to each other and pressure-bonded at 100° C. at 1 MPa for 5 minutes, and then the molds were removed. Thus, a polymer electrolyte membrane having fine unevenness provided on both surfaces of the Nafion bonded film was obtained.

### Example 4

As a monomer solution for a polymer electrolyte membrane, 0.1 mole of sodium p-styrene sulfonate (manufactured by Wako Pure Chemical Industries, Ltd.), 0.5 mole of 2-methacryloyloxyethyl acid phosphate (manufactured by Kyoeisha Chemical Co.), 0.03 mole of trimethylolpropane triacrylate (manufactured by Kyoeisha Chemical Co.), and 150 g of methanol as a solvent were mixed to make a mixed solution.

Two of the molds used in Example 2 were prepared, and a surface of each mold was coated with the monomer solution in a dry film thickness of 50 μm and dried. The monomer surface of each mold was irradiated with an electron beam at an accelerating voltage of 100 kV at a dose of 50 kGy to effect curing. Further, the cured surfaces of the two molds were attached to each other and pressure-bonded at 100° C. at 1 MPa for 5 minutes, and then the molds were removed. Then, a treatment with a 0.2 M aqueous sulfuric acid solution at 80° C. was conducted. Thus, a polymer electrolyte membrane having fine unevenness provided on both surfaces was made.

### Comparative Example 1

As an electrolyte membrane, a sheet of Nafion 112 (perfluorosulfonic acid film manufactured by DuPont) similar to that used in Example 1 was used as such.

(Evaluation)

(Average Surface Roughness Measurement and Surface Area Ratio Measurement)

The average surface roughness Ra′ and surface area ratio Sr of the surfaces of the polymer electrolyte membranes made in Examples 1 to 4 and Comparative Example 1 were measured using a scanning probe microscope SPI-3800 manufactured by Seiko Instruments Inc. at DFM mode.

The results are shown in Table 1.

TABLE 1

| | Average Surface Roughness | Surface Area Ratio |
|---|---|---|
| | (Ra′) (nm) | (Sr) |
| Example 1 | 33 | 1.5 |
| Example 2 | 450 | 1.2 |
| Example 3 | 300 | 1.4 |
| Example 4 | 320 | 1.4 |
| Comparative | less than 5 | 1.0 |
| Example 1 | | |

(Electron Microscope Observation of Surface of Polymer Electrolyte Membranes)

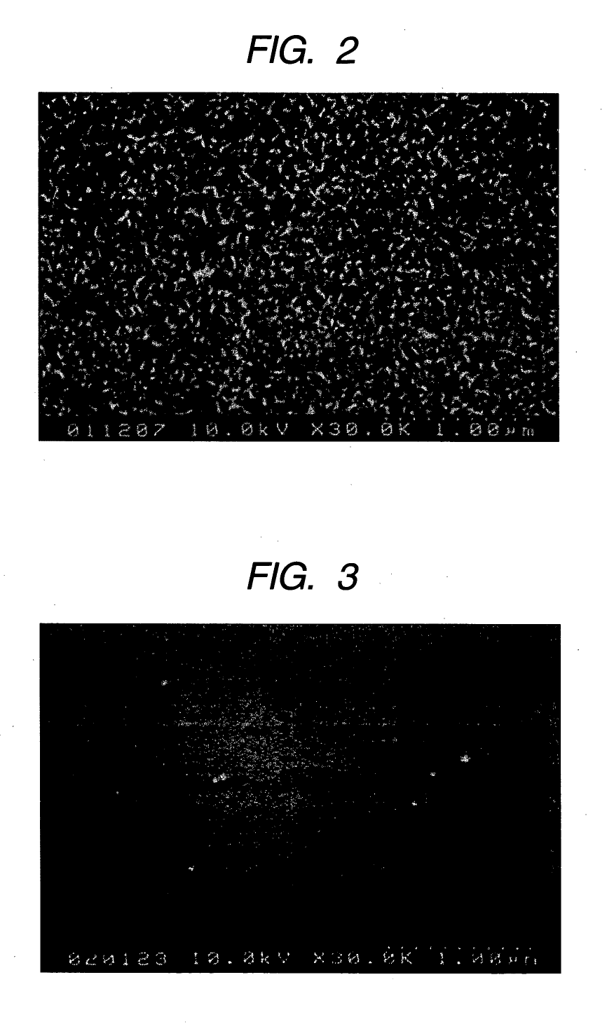

An electron microphotograph of the surface of the thin film of the polymer electrolyte membrane of Example 4 is shown in FIG. 2.

An electron micrograph of the surface of the thin film of the polymer electrolyte membrane of Comparative Example 1 is shown in FIG. 3.

(Measurement of Voltage-Current Curve of Fuel Cells)

4 g of catalyst (40 wt % platinum/20 wt % ruthenium) carrying conductive carbon IEPC40A-II (manufactured by Ishifuku Metal Industry Co., Ltd.) was mixed with 10 g of water and 8 g of a 5% Nafion solution (manufactured by Wakb Pure Chemical Industries, Ltd.) to make a paste.

This paste was coated on the surfaces of the polymer electrolyte membranes in Examples 1 to 4 and Comparative Example 1 and dried. The amount of coating of the platinum-ruthenium alloy at this time was about 4 mg/cm². Then, 0.2 mm thick carbon paper (TGP-H-060 manufactured by Toray Industries, Inc.) was brought into close contact with the coated surfaces and pressed at 100° C. at 50 kg/cm² to make a MEA (Membrane Electrode Assembly).

The thus made MEAs were each incorporated into a fuel cell to complete cells. The cell area is 25 cm².

For each cell, pure hydrogen and air were supplied to the fuel electrode and the air electrode respectively at 0.3 MPa in such a manner that the utilization rates of these were 40% and 80% respectively. While the whole cell was maintained at 80° C., electric power was generated.

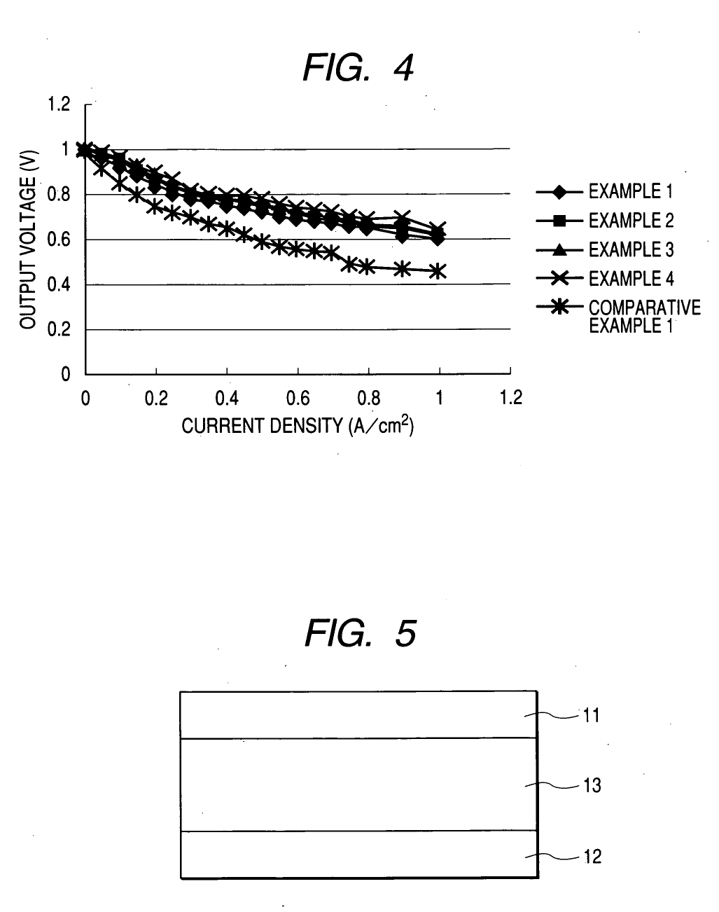

The relationship between current and voltage in each of the cells using the electrolyte membranes of Examples 1 to 4 and the cell using the electrolyte membrane of Comparative Example 1 is shown in FIG. 4. It can be seen from FIG. 4 that in each of the fuel cells of the present invention in Examples 1 to 4, an output can be taken out stably up to 1 A/cm², while in Comparative Example 1, only a current amount less than those in Examples 1 to 4 can be taken out. It can be seen that this is because, by setting the average surface roughness (Ra′) of the electrolyte membrane to be 30 nm to 500 nm and the surface area ratio (Sr) of the electrolyte membrane to be 1.2 or more, the reaction area increased, so that the efficiency of electric power generation improved.

By specifically defining the average surface roughness Ra′ and surface area ratio Sr, the polymer electrolyte membrane of the present invention can be utilized to provide a polymer electrolyte fuel cell that improves the efficiency of contact between the polymer electrolyte membrane and the catalyst, efficiently separates hydrogen ions and electrons produced on the catalyst, and shows high output characteristics.

This application claims priority from Japanese Patent Application No. 2003-382582 filed on Nov. 12, 2003, which is hereby incorporated by reference herein.

1. A polymer electrolyte membrane having at least one surface with an average surface roughness Ra′ of from 30 nm to 500 nm and a surface area ratio Sr of 1.2 or more in which Sr is defined as S/S₀ with S₀ representing a surface area when the at least one surface is ideally flat and S representing an actual surface area of the at least one surface.

2. A polymer electrolyte fuel cell comprising a polymer electrolyte membrane having at least one surface with an average surface roughness Ra′ of from 30 nm to 500 nm and a surface area ratio Sr of 1.2 or more in which Sr is defined as S/S₀ with S₀ representing a surface area when the at least one surface is ideally flat and S representing an actual surface area of the at least one surface.
